(19) United States
(12) Patent Application Publication
(10) Pub. No.: US 2004/0226046 A1
(43) Pub. Date: Nov. 11, 2004

(54) Telecommunication network-based remote surveillance method and system

(76) Inventors: Shih-Hsiung Weng, Taipei (TW); Wei-Seng Yeap, Penang (MY)

Correspondence Address: BIRCH STEWART KOLASCH & BIRCH, PO BOX 747, FALLS CHURCH, VA, 22040-0747, US

(21) Appl. No.: 10/428,939

(22) Filed: May 5, 2003

(51) Int. Cl. H04N 7/18

(52) U.S. Cl. 725/105; 348/143

(57) ABSTRACT

A telecommunication network-based remote surveillance method and system with the capability of turning on a remote surveillance system via telecommunication networks receives and determines signals from telecommunication networks. The on/off control unit then transforms the signals into turn-on signals, checks the storage space, and turns on the surveillance system. The image capture device captures images and stores the captured images into storage. Finally, the image display device displays the images.

### FIELD OF THE INVENTION

The invention is related to a remote surveillance method and system, especially to a remote method and system based on telecommunication networks.

### BACKGROUND OF THE INVENTION

Nowadays, surveillance systems are widely used in various areas. With the increasing popularity of surveillance systems, in addition to demands for image quality and control functions, users don't want to be limited by distances. How to design an efficient surveillance system becomes an important issue. Known surveillance systems only can control local systems and cannot control remote systems. Although surveillance systems by remote controllers are proposed, the flexibility of the system are still limited since the coverage of remote controllers is limited.

### SUMMARY OF THE INVENTION

To solve the mentioned problem, the invention proposes a telecommunication network-based remote surveillance method and system, enabling users to monitor another location via telecommunication networks anywhere.

The invention proposes a telecommunication network-based remote surveillance method which is able to turn on a remote surveillance system via telecommunication networks by the following steps: receiving and determining signals from telecommunication networks, transforming the signals into turn-on signals, checking the storage space, turning on the surveillance system, capturing images, and storing these images into the storage.

In addition, the invention proposes a telecommunication network-based remote surveillance system comprising: an on/off control unit which receives and determines signals from telecommunication networks and transforms the signals into surveillance signals; an image capture device which captures images after receiving a turn-on signal from the on/off control unit; an image storage device which checks the storage space, processes the captured images and stores the processed images into the storage; and an image display device 440 which displays images.

The proposed telecommunication network-based remote surveillance method and system increase the flexibility by enabling user to turn on/off the surveillance system via telecommunication networks. When surveillance is unnecessary, users can turn off the surveillance system in time and hence the storage requirement is reduced. The proposed method and system check whether the storage runs out, and users can specify a storage device when the storage space is available via telecommunication networks. Otherwise, the proposed method and system automatically turn off the surveillance system when the storage runs out. Before being turned on, the system checks the users' authorities by requesting users to input their passwords.

The detailed contents and concepts of the invention are described below.

### DETAILED DESCRIPTION

FIG. 1 shows the main flowchart of the proposed method. The proposed method and system receive signals and determine from telecommunication networks (Step 110), transform the signals into turn-on signals (Step 120), check the storage space (Step 130), turn on the surveillance system, capture images (Step 140), and store these images into the storage (Step 150).

FIG. 2 shows the flowchart of the proposed method, checking the storage space. Before being turned on, the system checks the availability of the storage (Step 210). The system informs users when the storage runs out. Otherwise, The system informs users to specify a storage device, such as a hard disk or a floppy disk, for storing the captured images (Step 220). The system then configures the storage device according to users' choices (Step 230).

After configuring the storage device, the system stores the captured images. The system usually monitors a location for a long time, and hence, requires a larger storage space. To reduce the required storage space, the invention compresses the images before storing them.

FIG. 3 shows the flowchart of the proposed method storing the captured images. After capturing an image (Step 310), the system compares the captured image with the previous image (Step 320),cut off the similar and stores the differences between these two images according to the results of the comparison (Step 330).

FIG. 4 shows the system architecture of the proposed system, which comprises:

an on/off control unit (410), receiving signals fiom telecommunication networks, determines the signals according to the users' configurations, transforms the signals into turn-on signals, and turns on the surveillance system;

an image capture device (420) which starts to capture images after receiving turn-on signals from the on/off control unit;

an image storage device (430) which checks whether the storage runs out, configures the storage device according to the users' choices if the storage space is available, processes the capture images, and stores the processed images; and

an image display device (440) which displays the images.

The determination of signals from telecommunication is set up by a configuration unit, to determine whether the signals are surveillance signals. The mentioned architecture also comprises an authentication unit to determine users' authorizations by comparing the user input with stored passwords. In addition, the architecture comprises an encoder and a decoder to encode and decode video and audio signals.

FIG. 5 shows a design of a home surveillance system. The surveillance system can be turned on via public switched telephone network (abbreviated as PSTN). The telephone (520) comprises an on/off control unit to turn on/off the surveillance system. A camcorder (530) captures images and transforms these images into video signals. The captured images are stored in a storage and control device (510).

FIG. 6 shows the flowchart of the home surveillance system. Users should configure the turn-on criterion. The turn-on criterion may be configured to turn on the surveillance system when the telephone has rung for several seconds. The turn-on criterion may be configured to turn on the surveillance system when the users press some pre-specified buttons after the call has been established. Users dial the home telephone by PSTN (Step 5110). After the phone has rung for several seconds, the system requests the users to leave a voice message or to turn on the surveillance system (Step 6111). The users press a button to turn on the surveillance system (Step 6112). The authentication unit requests the users to enter their passwords (Step 6113), compares the input with stored passwords (Step 6114), and determines the users' authorities. If the input and stored passwords are not the same, the authentication unit requests the users to re-enter the passwords or quit the system. If the input and stored passwords are the same (Step 6115), the system checks whether the storage runs out (Step 6116). If hard disks and floppies have free space, the system requests the users to specify a storage device. If the users specify a hard disk (Step 6117), the system connects the camcorder to the hard disk and turns on the surveillance system to capture images. After the camcorder has captured an image (Step 6118), the system compares this with previous images (Step 6119), and only stores the difference between these images. This can greatly increase the compression- efficiency.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments not departing from the spirit and scope of the invention.

### BRIEF DESCRIPTION OF THE DRAWINGS

FIG. 1 is the main flowchart of the proposed method.

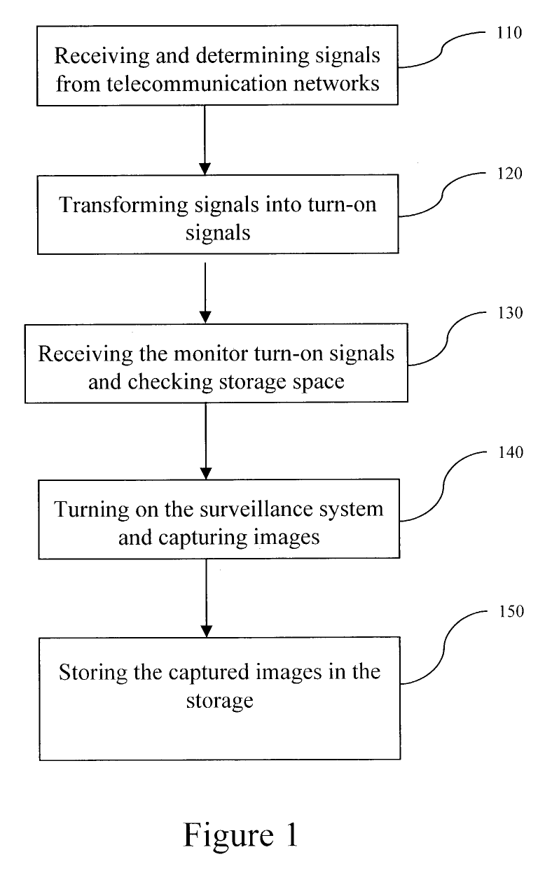

FIG. 2 is the flowchart of the proposed method checking the storage space.

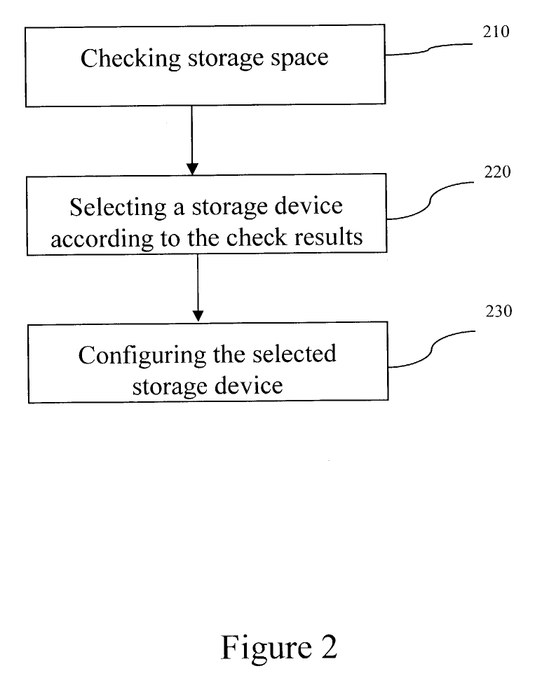

FIG. 3 is the flowchart of the proposed method storing the captured images.

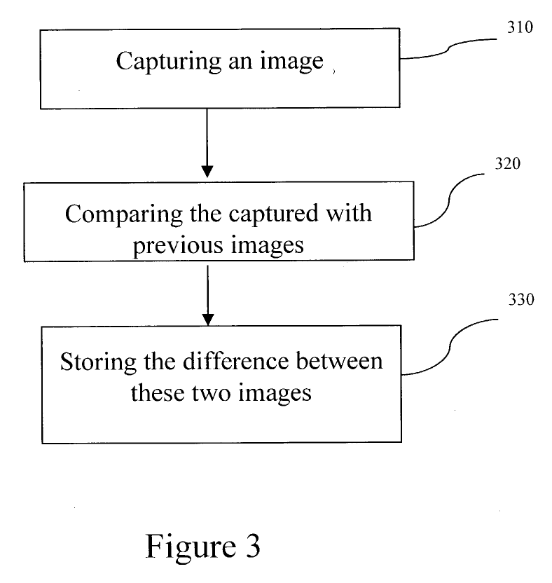

FIG. 4 is the system architecture of the proposed system.

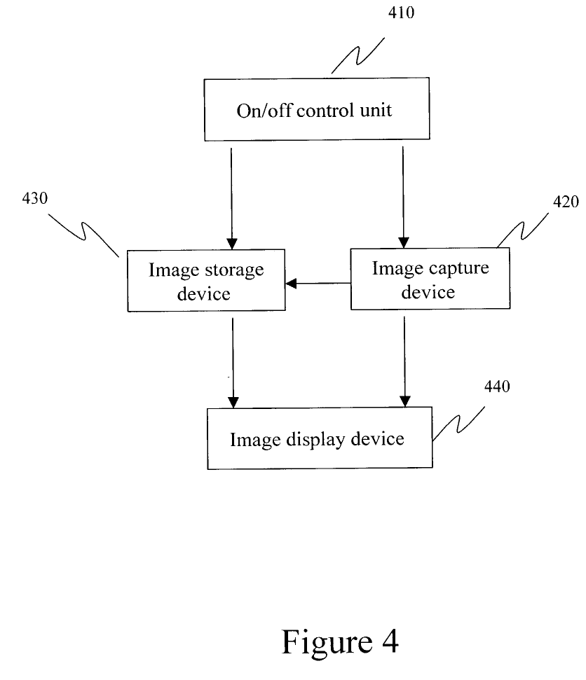

FIG. 5 is a design of a home surveillance system.

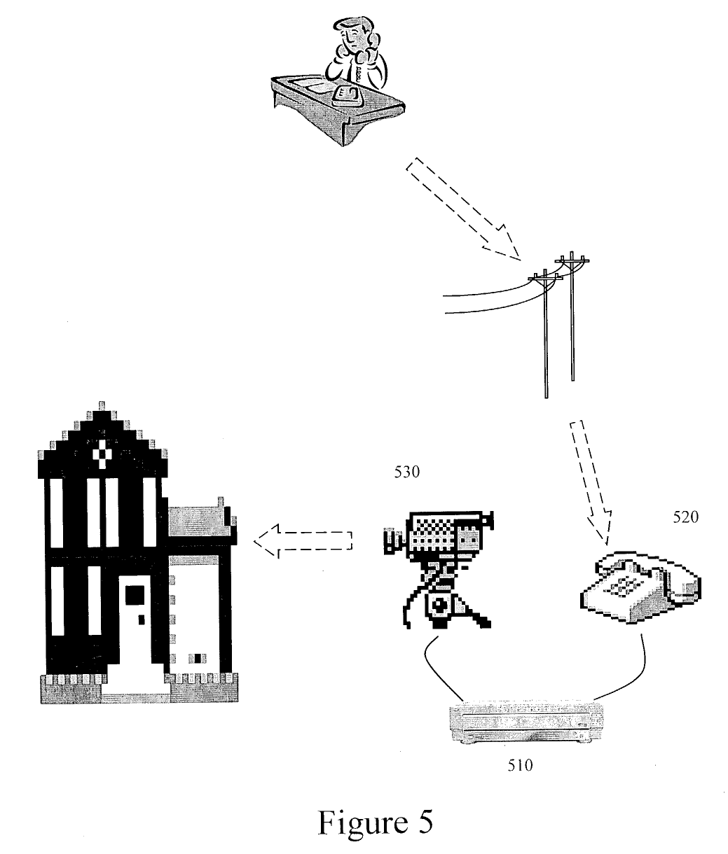

FIG. 6 is the flowchart of the home surveillance system.

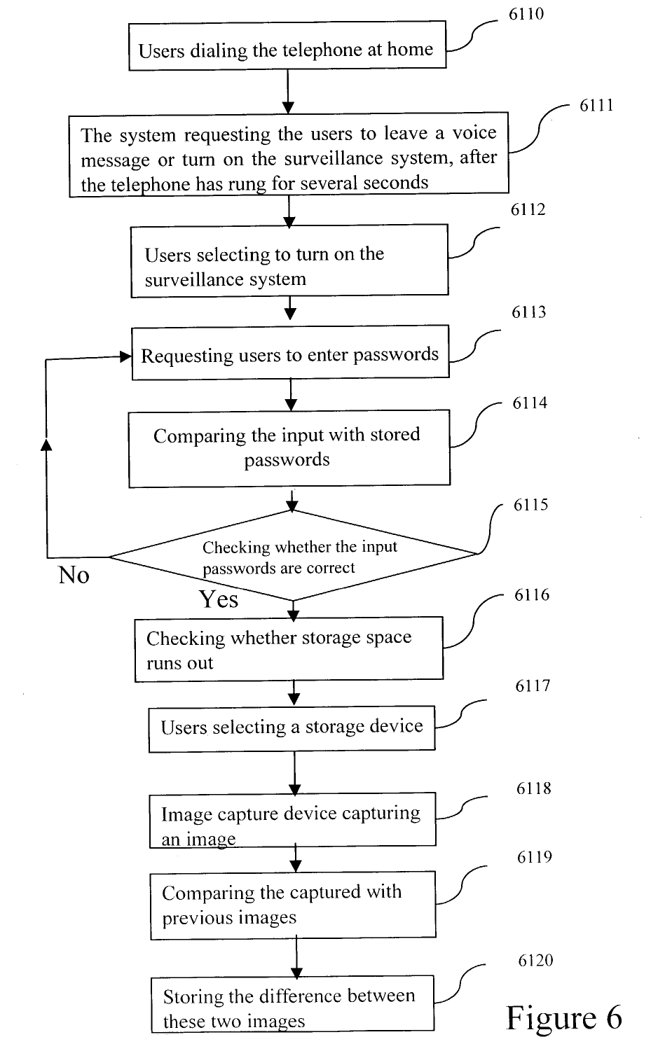

### Legend of the Drawings

Step 110 Receiving and determining signals from telecommunication networks

Step 120 Transforming signals into turn-on signals

Step 130 Receiving the turn-on signals and checking storage space

Step 140 Turning on the surveillance system and capturing images

Step 150 Storing the captured images in the storage

Step 210 Checking storage space

Step 220 Selecting a storage device according to the check results

Step 230 Configuring the selected storage device

Step 310 Capturing an image

Step 320 Comparing the captured with previous images

Step 330 Storing the difference between these two images

410 On/off control unit

420 Image capture device

430 Image storage device

440 Image display device

510 Storage and control device

520 Telephone

530 Camcorder

Step 6110 Users dialing the telephone at home

Step 6111 The system requesting the users to leave a voice message or turn on the surveillance system, after the telephone has rung for several seconds

Step 6112 Users selecting to turn on the surveillance system

Step 6113 Requesting users to enter passwords

Step 6114 Comparing the input with stored passwords

Step 6115 Checking whether the input passwords are correct

Step 6116 Checking whether storage space runs out

Step 6117 Users selecting a storage device

Step 6118 Image capture device capturing an image

Step 6119 Comparing the captured with previous images

Step 6220 Storing the difference between these two images

What is claimed is:

1. A telecommunication network-based remote surveillance method with the capability of turning on a remote surveillance system by telecommunication networks, comprising:
receiving and determining signals from telecommunication networks;
transforming the signals into turn-on signals;
receiving the turn-on signals and checking storage space;
turning on the surveillance system to capture images; and
storing the captured images into the storage device.

2. The method in accordance with claim 1, wherein the said determining signals from telecommunication networks is to transform the signals into turn-on signals when the turn-on criterion is satisfied.

3. The method in accordance with claim 2, wherein the said turn-on criterion is pre-specified.

4. The method in accordance with claim 2, wherein the said turn-on criterion is the time that the telephone has rung.

5. The method in accordance with claim 1, wherein the authentication steps comprise:
requesting users to enter passwords;
comparing the input with stored passwords; and
determining the users' authorization according to the results of comparison.

6. The method in accordance with claim 1, wherein the steps to check storage space comprise:
checking whether the storage runs out;
selecting a storage device according to the check results; and
configuring the selected storage device.

7. The method in accordance with claim 1, wherein the steps to storing the images into the storage device is compressing the image by Frame Correlation Algorithm, comprising:
Capturing an image;
Comparing the image with the previous image; and
Cutting off the similar and storing the difference between these two image according to the result of the comparison.

8. A telecommunication network-based remote surveillance system which can turn on a remote surveillance system by telecommunication networks, comprising:
an on/off control unit receives and determines signals from telecommunication networks and transforms the signals into turn-on signals;
an image capture device which starts to capture images after receiving a turn-on signal from the on/off control unit;
an image storage device which checks whether the storage runs out, processes the capture images, and stores the processed images; and
an image display device (440) which displays the images.

9. The system in accordance with claim 8, wherein the system comprises an authentication unit to determines users' authorizations by comparing the input with stored passwords.

10. The system in accordance with claim 8, wherein the system comprises a configuration unit to receive the turn-on criterion specified by users.

11. The system in accordance with claim 8, wherein the system comprises an encoder and a decoder.
